(19) United States
(12) Patent Application Publication
(10) Pub. No.: US 2026/0110638 A1
(43) Pub. Date: Apr. 23, 2026

(54) METHODS FOR QUANTITATIVELY ANALYZING CHROMATE COATINGS ON METAL SUBSTRATES

(71) Applicant: Missouri Highways and Transportation Commission, Jefferson City, MO (US)

(72) Inventor: Robert Sam Marshall, Jefferson City, MO (US)

(21) Appl. No.: 18/918,313

(22) Filed: Oct. 17, 2024

(51) Int. Cl. G01N 21/73; G01N 1/38; G01N 1/40

(52) U.S. Cl. CPC G01N 21/73; G01N 1/38; G01N 1/4044

(57) ABSTRACT

The present disclosure is directed to methods of quantitatively analyzing chromate coatings, more particularly, to methods of determining mass and/or mass-per-unit-area of chromate coatings on metal substrates.

### FIELD

The field of the disclosure relates to methods of quantitatively analyzing chromate coatings, more particularly, to methods of determining mass and/or mass-per-unit-area of chromate coatings on metal substrates.

### BACKGROUND

Chromate coatings are used to improve corrosion resistance of a metal substrate. For example, aluminum substrates used for highway or road signs typically include chromate coatings that render the signs resistant to environmental corrosion and extend the useful lifetime of the signs. Chromate coatings can be formed by immersing the metal substrate in a chromic acid solution until the chromate coating having a desired film thickness is formed. Alternatively, chromate coatings can be formed using electrochemical deposition processes.

The thickness of the chromate coating is an important characteristic that enables the coating to provide adequate corrosion resistance for a desirable time period. Determining or confirming the thickness of chromate coatings requires test methods since these coatings are relatively thin and, in at least some instances, generally transparent. The standard test method for analyzing chromate coatings on aluminum substrates is ASTM B 449. This is a qualitative method, and does not provide an actual determination of coating mass or thickness, only an indication of the presence of chromium on the substrate. This standard method also uses dangerous chemicals and creates an abundance of hazardous waste. Another standard method includes immersing a coated substrate into a solution of sodium nitrite (NaNO₂) at a temperature between 620 to 670° F., and weighing the substrate before and after the sodium nitrite treatment. This method, like ASTM B 449, is dangerous and hazardous and does not produce accurate results on a consistent basis. Other coating test methods such as scanning electron microscope (SEM) analysis are expensive, require complex instrumentation, and are generally inaccessible to most industrial and/or contractor sign production shops that perform the coating process.

Accordingly, there is a need to address the limitations associated with existing test methods for analyzing chromate coatings and to provide quantitative test methods that accurately, reliably, and consistently provide a determination of coating mass and/or coating mass-per-unit-area of the substrate, which doing so in a safe and cost-effective manner.

This background section introduces various aspects of the art that may be related to various aspects of the present disclosure described and/or claimed below. This discussion is intended to provide information to facilitate a better understanding of the various aspects of the present disclosure and the technical advantages provided. Accordingly, the statements made in this background section are to be read in this light, and are not admissions of prior art.

### BRIEF DESCRIPTION

One aspect of the present disclosure is directed to a method of quantitatively analyzing chromium in a chromate coating on a substrate. The method comprises: immersing the substrate including the chromate coating in an acid for a duration sufficient to extract the chromium into an extracted solution; and performing quantitative analysis of the extracted solution using optical emission spectroscopy to determine a concentration of the chromium in the extracted solution.

Another aspect of the present disclosure is directed to a method of determining a mass of a chromate coating on a substrate. The method comprises: immersing the substrate including the chromate coating in an acid for a duration sufficient to extract chromium into an extracted solution; performing quantitative analysis of the extracted solution using optical emission spectroscopy to determine a concentration of the chromium in the extracted solution; and calculating the mass of the chromate coating based on the concentration of the chromium in the extracted solution and a volume of the extracted solution.

Yet another aspect of the present disclosure is directed to a method of determining a mass-per-unit-area of a chromate coating on a substrate. The method comprises: immersing the substrate including the chromate coating in an acid for a duration sufficient to extract chromium into an extracted solution; performing quantitative analysis of the extracted solution using optical emission spectroscopy to determine a concentration of the chromium in the extracted solution; and calculating the mass-per-unit-area of the chromate coating based on the concentration of the chromium in the extracted solution, a volume of the extracted solution, and a surface area of the substrate.

### DETAILED DESCRIPTION OF THE DISCLOSURE

Embodiments of the present disclosure relate to test methods for quantitatively analyzing a chromate coating on a substrate (e.g., aluminum). The methods of the present disclosure include immersing the substrate including the chromate coating in an acid for a duration sufficient to extract (e.g., dissolve) the chromium into an extracted solution, and performing quantitative analysis of the extracted solution using optical emission spectroscopy to determine a concentration (e.g., milligrams per liter, mg/L, or parts per million, ppm) of the chromium in the extracted solution. The methods of the present disclosure are reliable, accurate, and consistent, operate with relatively low hazard materials (e.g., dilute acid) and relatively safe conditions, and can be performed without complex instrumentation.

Chromate coatings that are analyzed in accordance with methods of the present disclosure can be used to improve corrosion resistance of the substrate. Chromate coatings can additionally or alternatively be used to impart or improve other properties of the substrate, including inertness of the surface of the substrate, better adhesion for subsequent coatings (e.g., paints or electroplating), and/or brightness of the substrate. In some embodiments, the chromate coating includes bright chromates, colored chromates, black chromates, or another chromate type. The type of chromate coating can vary depending on a thickness, chromium content, other element content, and so forth. The methods of the present disclosure can be used to quantitatively analyze any type of chromate coating.

In some embodiments, the chromate coating includes hexavalent chromium and/or non-hexavalent chromium. Hexavalent chromium (Cr^{VI} or Cr(VI)) is a common chemistry included in chromate coatings designed to provide corrosion resistance. Recently, there is a trend towards using non-hexavalent chromium (e.g., trivalent chromium, Cr^{III} or Cr(III)) due to the toxicity and the hazards that hexavalent chromium poses to human health and the environment. Trivalent chromium has been shown to be a suitable alternative to hexavalent chromium in providing protection against corrosion, and is generally less harmful to the environment and human health. This non-hexavalent chromate treatment is acceptable per ASTM B 921 using different testing standards. However, ASTM B 449 remains the current and most used treatment option.

Chromate coatings can be applied or deposited on the substrate using any suitable technique, generally referred to as a chromate conversion coating process or “chromating.” In some embodiments, chromating is performed by immersing the substrate in a chromic acid solution to form the chromate coating. In various embodiments, chromating includes reactive chromating, application chromating, electrolytic chromating, or electrochemical chromating. The chromating method used to form the chromate coating is not particularly limited, and the methods of the present disclosure can be used to quantitatively analyze a chromate coating formed by any type of chromating, on any suitable type of substrate. The chromate coatings are also referred to as chromate conversion coatings.

Chromating can be performed for a suitable duration to achieve a desired thickness of the chromate coating. The methods of the present disclosure are not limited to any particular thickness of the chromate coating. In some embodiments, the chromate coating has a thickness between 0.1 micrometers to 1 micrometer. In other embodiments, the chromate coating has a thickness that is thinner than 0.1 micrometers or thicker than 1 micrometer.

In some embodiments, the test methods described herein are used for quantitatively analyzing a chromate coating on a metal substrate. Suitable metal substrates include those that are used in environments that present a risk of corroding the metal substrate. For example, the metal substrates used in accordance with methods of the present disclosure include those that are used in outdoor applications, industrial and manufacturing applications, tools, screws, automobiles, household electrical appliances, or any other suitable application.

Metal substrates that can include a chromate coating in accordance with the present disclosure are not particularly limited. In various embodiments, the chromate coating is formed on a metal substrate that includes a material selected from the group consisting of aluminum, zinc, steel, cadmium, copper, silver, magnesium, tin, and alloys of these metals. In certain embodiments, the chromate coating is formed on an aluminum substrate. Aluminum substrates may be used in outdoor applications, such as highway signs or road signs, that present a risk of corroding the substrate. Another example of suitable metal substrates includes zinc-plated steel substrates.

The extracted solution is produced by extracting (dissolving) chromium from the substrate using the acid. In embodiments, the substrate including the chromate coating is immersed in the acid for a suitable duration to enable the chromium to be extracted or dissolved by the acid to produce the extracted solution. In some embodiments, the duration ranges from between 1 hour to 72 hours, between 4 hours to 48 hours, between 8 hours to 24 hours, or between 12 hours to 20 hours.

The acid used to produce the extracted solution includes any suitable acid that can extract or dissolve chromium in the chromate coating. For example, the acid includes nitric acid (HNO₃). The acid (e.g., nitric acid) can be diluted in an aqueous solution prior to extracting the chromium. For example, the acid used to produce the extracted solution is diluted to lower than 50% in aqueous solution. In some embodiments, the acid is an aqueous solution including nitric acid in a range between 25% to 35% nitric acid, or about 30% nitric acid. Suitably, the acid is compatible with the substrate. In other words, the acid is suitable selected such that it does not corrode the substrate.

In some embodiments, the extracted solution is diluted in a diluent prior to the optical emission spectroscopy analysis. In some embodiments, the diluent includes the acid in a diluted solution. For example, the diluent includes nitric acid in a diluted aqueous solution. In one embodiment, the diluent includes a diluted aqueous solution of between 2% to 5% (e.g., 1:24) nitric acid.

In some embodiments, the concentration of the chromium in the extracted solution is determined using inductively coupled plasma optical emission spectroscopy (ICP-OES). Any suitable optical emission spectroscopy (OES) technique can be used to quantitatively analyze the extracted solution.

The concentration of chromium in the extracted solution can be determined by comparing an intensity of chromium detected in the extracted solution by OES (e.g., ICP-OES) against a calibration curve. The calibration curve can be generated using two or more standard chromium solutions that range in chromium concentration. For example, the standard chromium solutions can range from between 0 ppm chromium (blank standard) to 10 ppm chromium. In some embodiments, the calibration curve can be generated using a 0 ppm chromium (blank) standard, a 0.1 ppm chromium standard, a 0.25 ppm chromium standard, a 0.5 ppm chromium standard, a 1.0 ppm chromium standard, a 2.5 ppm chromium standard, a 5.0 ppm chromium standard, and a 10 ppm chromium standard. Any sub-combination of these standards can be used. In some embodiments, standards exceeding 10 ppm chromium can also be used to generate the calibration curve. A target correlation coefficient of 0.9999 or higher is desired for the calibration curve.

In some embodiments, the standards used to generate the calibration curve include a stock solution of chromium in an aqueous solution of the acid used to extract the chromium. For example, the standards include a stock solution of chromium at a desired concentration in an aqueous solution of nitric acid. In some embodiments, the standards include a stock solution of chromium at the desired concentration in a 1% to 5% (e.g., 2%) aqueous solution of nitric acid.

After the concentration of chromium in the extracted (and optionally diluted) solution is determined, in some embodiments, the mass of the chromate coating is calculated. The mass of the chromate coating can be calculated based on the determined concentration and the volume of the extracted solution according to the following Equation 1:

$$Mass of Chromate Coating = ( Chromium Concentration ) \times ( Volume of Solution ) \qquad Eq . 1$$

In some embodiments, the mass-per-unit-area of the chromate coating is calculated based on the determined concentration, the volume of the extracted solution, and the surface area of the substrate on which the chromate coating is formed. The mass-per-unit-area (MPUA) can be calculated according to the following Equation 2:

$$MPUA of Chromate Coating = ( ( Chromium Concentration ) \times ( Volume of Solution ) ) / ( Surface Area of Substrate ) \qquad Eq . 2$$

In embodiments where the extracted solution is diluted prior to OES analysis, the volume of solution used to calculate the mass and/or MPUA of the chromate coating includes the volume of the diluent.

### Examples

Aspects of the present disclosure will now be described with reference to the following non-limiting examples.

Quantitative analysis using the techniques of the present disclosure was performed to analyze chromate coating on aluminum extruded panels used for overhead guide signs and flat sheets used to produce regulatory and warning signs. Some of the panels/flat sheets included hexavalent chromate coating. Others of the panels/flat sheets included non-hexavalent chromate coating.

The extruded panels/flat sheets including the chromate coating were cut into sample coupons having a known size such that the sample coupons fit into a 400 mL beaker. Each sample was analyzed as follows:

The sample was covered with approximately 50 mL of 30% nitric acid solution in a 400 mL beaker. A watch glass was placed over the beaker and the solution was allowed to sit overnight to produce the extracted solution. The extracted solution was then quantitatively transferred from the 400 ml beaker to a 100 mL volumetric flask. The extracted solution was diluted to volume with 1:24 nitric acid solution. The diluted, extracted solution was then transferred to a 70 mL propylene vial for ICP-OES analysis.

To generate a calibration curve for the ICP-OES analysis, standards were prepared ranging from 0.1 to 10 ppm using chromium (Cr) stock solution of 1000 micrograms (μg)/mL in 2% nitric acid solution. The Cr standards prepared were as follows: blank, 0.1 ppm Cr, 0.25 ppm Cr, 0.5 ppm Cr, 1.0 ppm Cr, 2.5 ppm Cr, 5.0 ppm Cr, and 10 ppm Cr. The standards were run on the ICP-OES, and a calibration line was generated. A target correlation of 0.9999+ is desired for the calibration curve.

A laboratory control sample (LCS) of 10 ppm was run concurrently with the extracted Cr solution to validate results. If the result is under the highest standard (10 ppm), the result is multiplied by 100 since the extracted solution was brought up to 100 mL in the volumetric flask.

Quantitative analysis using the ICP-OES and the generated calibration curve was then performed. The concentration is reported as mg/L, determined based on the intensity of the Cr analyte (at 267.716 nm) against the calibration curve.

The mass (in mg) of the chromate coating on the sample can be calculated according to Eq. 1, where the concentration is the determined concentration from ICP-OES and the volume is 100 mL (or 0.1 L). Additionally or alternatively, the MPUA (in mg/ft²) of the chromate coating on the sample can be calculated according to Eq. 2, where the concentration is the determined concentration from ICP-OES, the volume is 100 mL (or 0.1 L), and the surface area is known from the size of the sample coupon (here, 0.0172 ft²).

In the foregoing specification and the following claims, reference is made to several terms, which have the following meanings.

The singular forms “a,” “an,” “the,” and “said” include plural references unless the context clearly dictates otherwise.

The terms “comprising,” “including,” and “having” are intended to be inclusive and mean that there may be additional elements other than the listed elements.

“Optional” or “optionally” means that the subsequently described event or circumstance may or may not occur, and that the description includes instances where the event occurs and instances where it does not.

References to “one embodiment” are not intended to be interpreted as excluding the existence of additional embodiments that also incorporate the recited features. Moreover, although specific features of various embodiments described herein may be shown in some drawings and not in others, this is for convenience only. In accordance with the principles of the present disclosure, any feature of a drawing and/or embodiment described herein may be referenced and/or claimed in combination with any feature of any other drawing and/or embodiment described herein. Furthermore, unless explicitly stated to the contrary, embodiments “including” or “having” an element or a plurality of elements having a particular property may include additional such elements not having that property.

This written description uses examples to disclose the embodiments, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of quantitatively analyzing chromium in a chromate coating on a substrate, the method comprising:
immersing the substrate including the chromate coating in an acid for a duration sufficient to extract the chromium into an extracted solution; and
performing quantitative analysis of the extracted solution using optical emission spectroscopy to determine a concentration of the chromium in the extracted solution.

2. The method of claim 1, wherein performing the quantitative analysis includes using inductively coupled plasma optical emission spectroscopy.

3. The method of claim 1, wherein the acid includes nitric acid.

4. The method of claim 1, wherein the chromium includes hexavalent chromium.

5. The method of claim 1, wherein the chromium includes non-hexavalent chromium.

6. The method of claim 1, further comprising diluting the extracted solution prior to performing the quantitative analysis.

7. The method of claim 6, wherein diluting the extracted solution includes diluting the extracted solution using a dilution solution including the acid.

8. The method of claim 7, wherein the acid includes nitric acid.

9. The method of claim 1, wherein the substrate includes aluminum.

10. A method of determining a mass of a chromate coating on a substrate, the method comprising:
immersing the substrate including the chromate coating in an acid for a duration sufficient to extract chromium into an extracted solution;
performing quantitative analysis of the extracted solution using optical emission spectroscopy to determine a concentration of the chromium in the extracted solution; and
calculating the mass of the chromate coating based on the concentration of the chromium in the extracted solution and a volume of the extracted solution.

11. The method of claim 10, wherein performing the quantitative analysis includes using inductively coupled plasma optical emission spectroscopy.

12. The method of claim 10, wherein the acid includes nitric acid.

13. The method of claim 10, further comprising diluting the extracted solution in a diluent prior to performing the quantitative analysis, wherein the volume of the extracted solution used to calculate the mass of the chromate coating includes a volume of the diluent.

14. The method of claim 13, wherein the diluent is a dilution solution including the acid.

15. The method of claim 10, wherein the substrate includes aluminum.

16. A method of determining a mass-per-unit-area of a chromate coating on a substrate, the method comprising:
immersing the substrate including the chromate coating in an acid for a duration sufficient to extract chromium into an extracted solution;
performing quantitative analysis of the extracted solution using optical emission spectroscopy to determine a concentration of the chromium in the extracted solution; and
calculating the mass-per-unit-area of the chromate coating based on the concentration of the chromium in the extracted solution, a volume of the extracted solution, and a surface area of the substrate.

17. The method of claim 16, wherein performing the quantitative analysis includes using inductively coupled plasma optical emission spectroscopy.

18. The method of claim 16, wherein the acid includes nitric acid.

19. The method of claim 16, further comprising diluting the extracted solution in a diluent prior to performing the quantitative analysis, wherein the volume of the extracted solution used to calculate the mass of the chromate coating includes a volume of the diluent.

20. The method of claim 16, wherein the substrate includes aluminum.
